(19) United States
(12) Patent Application Publication
(10) Pub. No.: US 2025/0337842 A1
(43) Pub. Date: Oct. 30, 2025

(54) MERGING OF SUPPLEMENTATIVE LIVE AUDIO TRANSFORMATION

(71) Applicant: Nagish Inc., New York, NY (US)

(72) Inventors: Tomer Aharoni, New York, NY (US); Alon Ezer, Hollywood, FL (US)

(73) Assignee: Nagish Inc., New York, NY (US)

(21) Appl. No.: 18/649,563

(22) Filed: Apr. 29, 2024

(51) Int. Cl. H04M 3/56; G09B 21/00

(52) U.S. Cl. CPC H04M 3/568; G09B 21/009; H04M 3/567

(57) ABSTRACT

The supplementation of an alternative form of audio in a communicative conference for the benefit of the hard of hearing includes first capturing audio in a communicative conference between different parties to the conference, and then transforming the captured audio into an alternative form so as to display the alternative form in connection with the communicative conference. The supplementation additionally includes invoking a companion window to the communicative conference with a view to a live audio interpreter. Finally, the supplementation includes merging the view to the live audio interpreter with the communicative conference and the alternative form, and transmitting the captured audio to the live audio interpreter while concurrently delivering the captured audio and the alternative form to at least one of the different parties of the conference.

### BACKGROUND OF THE INVENTION

### Field of the Invention

The present invention relates to the technical field of assistive technologies, and more particularly to the supplementation of an alternative representation of audio in a communications session with a real time transformation of the audio.

### Description of the Related Art

Assistive technology is a term for assistive, adaptive, and rehabilitative devices for people with disabilities and the elderly. An assistive technology is any item, equipment, software program, or product used to increase, maintain, or improve the functional capabilities of persons with disabilities. Assistive technologies can range from the mechanical to the electro-mechanical to the electronic to pure software, and include everything from prosthetics to computer programs. Assistive technologies have been known to help those who have difficulty speaking, typing, writing, remembering, pointing, seeing, hearing, learning, walking, and many other things. To that end, different disabilities require different assistive technologies.

Those who are deaf, “hard of hearing” or “HoH” require specific assistive devices in order to function at a near equivalent level to those without hearing impairment. Traditional assistive technologies for people with hearing loss include electronic hearing aids and in more sophisticated instances, cochlear implants. For many who are hard of hearing, the greatest challenge is communicating with those without hearing loss by means of communicative mechanisms including the traditional telephone or mobile phone, or in more modern instances, in an audio or video conference. As to the former, assistive devices such as teletype allow the party to the conversation who is hard of hearing to read a real-time text transcript of the speech of the other party to the conversation and, optionally, to respond in text which then can be text-to-speech (TTS) processed into audio.

As to the latter, assistive devices are relatively new to the marketplace and are a direct response to the recent migration to remote meetings facilitated by virtual meeting platforms. Such assistive devices generally provide real-time or near real-time transcription of audio in a virtual meeting using a speech recognition engine. However, it is widely understood that speech recognition is an imperfect mechanism and fairs poorly in conveying the context of the language of speech. To truly have accuracy in translation of speech while preserving some understanding of the context of delivery of the speech, those who are hard of hearing rely upon the long-standing assistive tool of live sign language translation.

But, live sign language translation is not a feasible option for a remote attendee to a virtual conference as the presence of the live translator in the same room or within eye shot of the virtual conference of the hard of hearing attendee. Further, for many who are hard of hearing, there is a strong desire to maintain an appearance of ordinary participation by obscuring or minimizing the awareness of the use of an assistive technology in the course of a virtual meeting.

### BRIEF SUMMARY OF THE INVENTION

Embodiments of the present invention address technical deficiencies of the art in respect to supplementing person to person conferencing with assistive communications to support the hard of hearing. To that end, embodiments of the present invention provide for a novel and non-obvious method for supplementation of an alternative form of audio in a communicative conference for the benefit of the hard of hearing. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for the supplementation of an alternative form of audio in a communicative conference for the benefit of the hard of hearing includes first capturing audio in a communicative conference between different parties to the conference, and then transforming the captured audio into an alternative form so as to display the alternative form in connection with the communicative conference. The method additionally includes invoking a companion window to the communicative conference with a view to a live interpreter such as an interpreter specializing in transforming audio into an American sign language (ASL) representation. Finally, the method includes merging the view of the live interpreter with the communicative conference and the alternative form, and transmitting the captured audio to the live interpreter while concurrently delivering the captured audio and the alternative form to at least one of the different parties of the conference.

In one aspect of the embodiment, the method additionally includes selecting the live interpreter from a selection of available live interpreters known to be available at a time of the invocation of the companion window. Alternatively, the live audio interpreter may be selected from a selection of available live interpreters in advance of initiating the communicative conference. In the former instance, several variant aspects alone or in combination are contemplated herein:
filtering the selection according criteria specified by the one of the different parties and pertaining to one or more demographic characteristics of the available live audio interpreters;
polling the selection of available live audio interpreters to join the communicative conference and selecting from amongst responding ones of the polled selection a first responding one of the selection of available live audio interpreters.
polling the selection of available live audio interpreters to join the communicative conference and selecting from amongst responding ones of the polled selection a responding one of the selection of available live audio interpreters with a highest recorded rating amongst the selection of available live audio interpreters.
   In even yet another aspect of the embodiment, the view may be presented to the live audio interpreter only to the at least one of the different parties of the conference while obscuring the view to the live audio interpreter with respect to remaining ones of the different parties of the conference.

In another embodiment of the invention, a data processing system is adapted for supplementing an alternative form of audio in a communicative conference for the benefit of the hard of hearing. The system includes a host computing platform of one or more computers, each with memory and one or processing units including one or more processing cores. The system also includes a conferencing client executing in the host computing platform and providing access to a communicative conference between different parties to the conference. The system yet further includes a supplementation module communicatively coupled to the conferencing client. The module includes computer program instructions enabled while executing in the memory of at least one of the processing units of the host computing platform to perform the supplementation of an alternative form of audio in a communicative conference for the benefit of the hard of hearing.

Specifically, the program instructions capture audio in the communicative conference, transform the captured audio into an alternative form and display the alternative form in connection with the communicative conference. The program instructions then invoke a companion window to the communicative conference with a view to a live audio interpreter. Finally, the program instructions merge the view to the live audio interpreter with the communicative conference and the alternative form, and transmit the captured audio to the live audio interpreter while concurrently delivering the captured audio and the alternative form to at least one of the different parties of the conference.

In this way, the technical deficiencies of inaccurate transcription of audio of a virtual meeting thus requiring live translation in a virtual meeting are overcome owing to the dynamic integration of live sign language translation from a remote location while preserving the ability to obscure or minimize the awareness of other participants to the virtual meeting of the interaction of the live translator with the virtual meeting.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of supplementing a communicative conference with an alternative form of audio for the benefit of the hard of hearing;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for the supplementation of a communicative conference with an alternative form of audio for the benefit of the hard of hearing. In accordance with an embodiment of the invention, an audio or video conference may be supplemented with a companion live sign language translation of the audio of the conference responsive to a request by a hard of hearing participant to the conference to select an available live translator from amongst a pool of available translators. In response to the request, a communicative channel is established between the conference and an audiovisual feed at a network endpoint associated with the selected translator. Audio (and, optionally video) from the conference is then relayed to the live translator over the communicative channel and video of the live translator performing live translation is displayed within a window of a device of the hard of hearing participant complimenting a display of the hard of hearing participant of the conference. In this way, the context of the conference can be captured by the live translator and presented to the hard of hearing participant, in concert with a live transcription of the audio of the conference, though the view to the live translator can be limited to only the display of the hard of hearing participant.

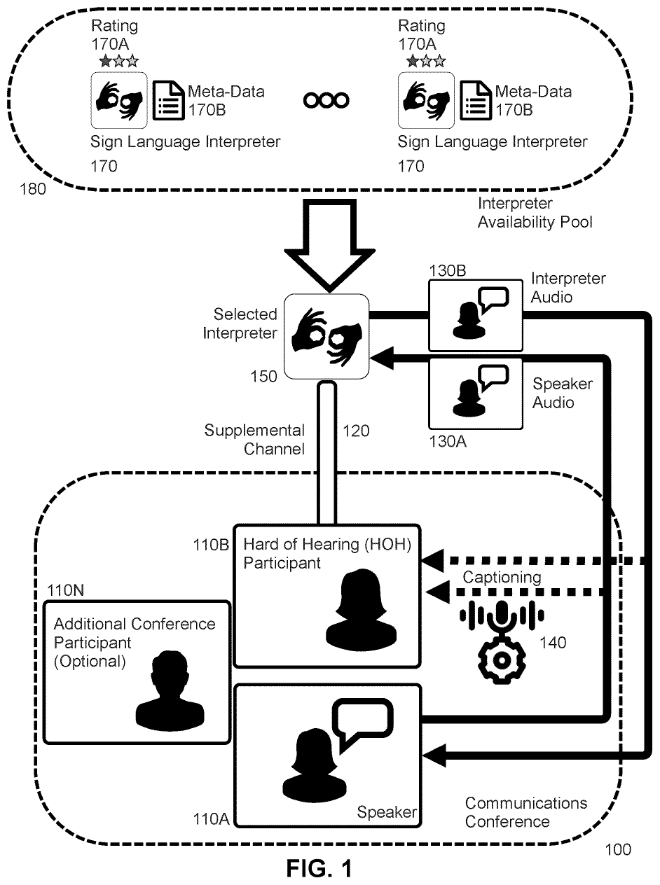

In illustration of one aspect of the embodiment, FIG. 1 pictorially shows a process of supplementing a communicative conference with an alternative form of audio for the benefit of the hard of hearing. As shown in FIG. 1, a communications conference 100 includes an audio conference between conference participants 110A, 110B and optionally an additional one or more participant 110N. A speaker 110A amongst the conference participants 110A, 110B speaks to produce speaker audio 130A intended for a hard of hearing one of the participants 110B, and the additional one or more participants 110N. But, the speaker audio 130A is provided to a selected sign language interpreter 150 in communication with the speaker 110A and the hard of hearing one of the participants 110B, in lieu of the speaker audio 130A being provided directly to the hard of hearing one of the participants 110B.

As such, a supplemental communications channel 120 is established as between the hard of hearing one of the participants 110B and the selected sign language interpreter 150 so that the an auxiliary stream 130 is also provided over the supplemental communications channel 120 and imagery of the selected sign language interpreter 150 signing the speech of the speaker audio 130A is presented in a display of the hard of hearing one of the participants 110B. Interpreter audio 130B is then provided by the selected interpreter 150 to the speaker 110A interpreting sign language communications of the hard of hearing one of the participants 110B.

Optionally, upon the directive of the hard of hearing one of the participants 110B to establish the supplemental channel 120, a listing of interpreters 170 in an interpreter availability pool 180 whom are available for real-time coupling over the supplemental channel 120 is presented to the hard of hearing one of the participants 110B in a window ancillary to a user interface of the communications conference 100. Each of the interpreters 170 in the pool 180 includes an associated rating 170A of effectiveness assigned based upon feedback from past conference participants, along with additional meta-data 170B such as demographic information of the corresponding one of the interpreters 170 such as geographic location or spoken languages, or a particular domain of expertise such as engineering, medicine, law, accounting, marketing, to name some generic examples.

A set of the interpreters in the pool 180 can then be selected based upon one or more criteria such as a minimum rating or specific demographic criteria and each in the set receives a prompt to accept an assignment in translating the auxiliary stream 130 of the communications conference 100. A first responding one of the interpreters 170 in the set is then selected as the selected interpreter 150. Of note, while the foregoing contemplates the active selection of the selected interpreter 150 from amongst interpreters 170 by the hard of hearing one of the participants 110B, it also is contemplated herein that the selection of the selected interpreter 150 from amongst the interpreters 170 can be automated programmatically to automatically select the selected interpreter 150 based upon the highest ranking of the interpreters 170 with respect to the criteria.

Importantly, captioning 140 is performed on the speaker audio 130A, such as speech recognition, in order to deliver to the hard of hearing one of the participants 110B a textual representation of the speech of the speaker audio 130A in a user interface of a communications device of the hard of hearing one of the participants 110B. As well, captioning 140 is performed on the interpreter audio 130B, such as speech recognition, in order to deliver to the hard of hearing one of the participants 110B a textual representation of the speech of the interpreter audio 130A in a user interface of a communications device of the hard of hearing one of the participants 110B. Consequently, the hard of hearing one of the participants 110B can fuse the information received in respect to sign language interpretation of the speaker audio 130A with the textual representation of the speaker audio 130A reflected in the captioning 140 in order to recognize the context of the speaker audio 130A that might otherwise be lost with only a sign language representation of the speaker audio 130 provided by the selected interpreter 150.

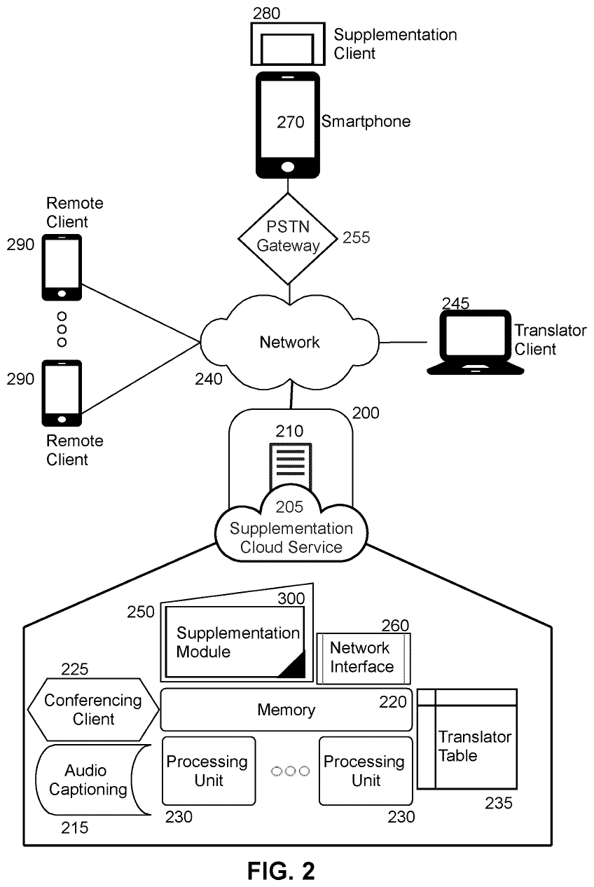

Aspects of the process described in connection with FIG. 1 can be implemented within a data processing system. In further illustration, FIG. 2 schematically shows a data processing system adapted to perform supplementing a communicative conference with an alternative form of audio for the benefit of the hard of hearing. In the data processing system illustrated in FIG. 1, a host computing platform 200 is provided. The host computing platform 200 includes one or more computers 210, each with memory 220 and one or more processing units 230. The computers 210 of the host computing platform 200 (only a single one of the devices 210 shown for the purpose of illustrative simplicity) can be co-located within one another and in communication with one another over a local area network, or over a data communications bus, or the computers can be remotely disposed from one another and in communication with one another through network interface 260 over a data communications network 240. The host computing platform 200 further is adapted for communicative coupling to different remote client devices 245 associated with respectively different sign language translators. Each one of the remote client devices can be a personal computer or a mobile computing device such as a tablet computer or smart phone.

The computer 210 supports the operation of a supplementation cloud service 205 through the deployment of a conferencing client 225 adapted for communication over the data communications network 240 with a supplementation client 280 hosted within remote communications system 270 such as a mobile phone, tablet computer or personal computer and accessing the data communications network 240 through public switched telephone network (PSTN) gateway 255. The conferencing client 225 renders a display in the computer 210 for transmission to the supplementation client 280 of a conference, audio or video, established between a hard of hearing end user of the remote communications system 270 and one or more other participants accessing the conference from respectively different remote communications systems 290. As it will be understood, other participants to the conference access the conference from respective remote communications systems 290 from over the data communications network 240.

The computer 210 also include an audio captioning module 215 configured to process audio of the conference into captioned text, for instance through the operation of a speech recognition engine, for ultimate display in concert with a view to the conference in the supplementation client. Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for supplementing a communicative conference with an alternative form of speech audio of the conference for the benefit of the hard of hearing, in supplement to the captioned text.

Specifically, the program instructions during execution render a control in connection with the view to the conference indicating a request to supplement the operation of the audio captioning module 215 with live translation of speech audio of the conference by a translator at one of the remote clients 245. Optionally, the program instructions upon activation of the control access a set of translators in translator table 235 disposed in the memory 220 in order to identify ones of the translators meeting a minimum rating and one or more demographic criteria. The program instructions then poll the identified translators and then the program instructions communicatively link a first responding a corresponding one of the remote devices 245 of one of the polled, identified translators to the conference so as to provide audiovisual access to the speakers of the conference in response to which the first responding one of the polled, identified translators provides sign language translation of the audio of the conference in a video feed to a window in the computer 210 in connection with the view to the conference.

It is to be noted that as shown herein, in a supplementation cloud service 205 aspect of the embodiment, the program code of the supplementation module 300 is accessed through the data communications network 240 with the supplementation cloud service 205 directing the supplementation client 280 of the remote communications system 270 to render a Web browser based user interface or a mobile app through which the end user accesses the program code of the supplementation module 300 in the supplementation cloud service 205. However, it also is to be noted, aspects of the embodiment can include transport of the program instructions of the supplementation module 300 into the memory of the remote communications system 270, the execution of the program instructions by a processor of the remote communications system 270, and the accessing by the program instructions of the supplementation module 300 of the translator table 235 disposed remotely from the supplementation cloud service 205 and within memory of the remote communications system 270.

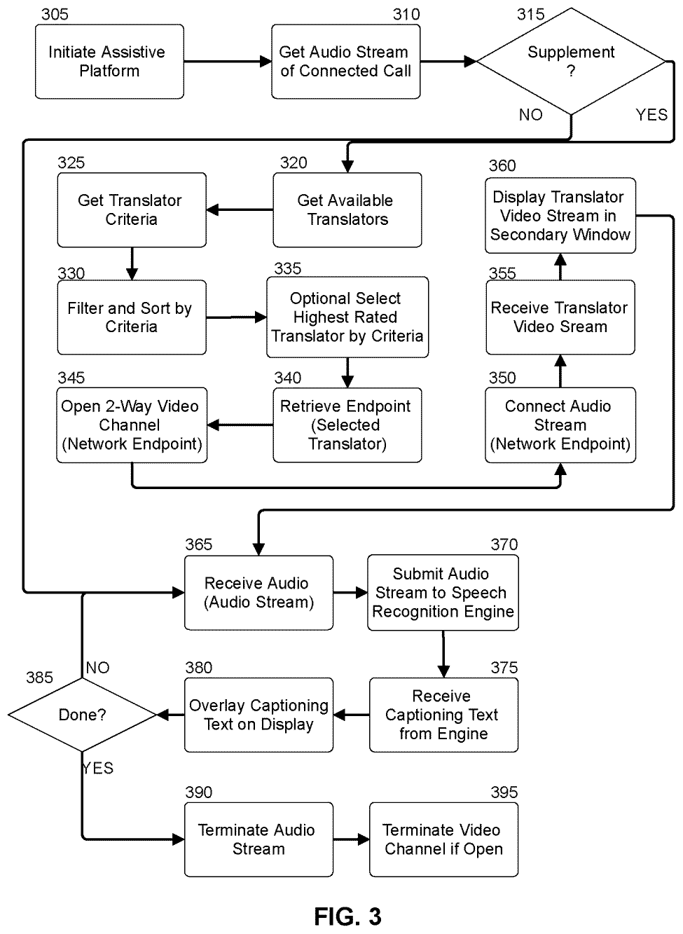

In further illustration of an exemplary operation of the module, FIG. 3 is a flow chart illustrating one of the aspects of the process of FIG. 1. Beginning in block 305, the assistive platform is invoked so as to provide an assistive technology to a hard of hearing conference participant to a conference. In block 310, an audio stream reflective of the speech of a speaker in the conference is received. In block 315, it is determined whether or not to supplement the conference with an assistive supplement. If not, in block 365, speech audio is received in the audio stream and in block 370, the speech audio is presented to a speech recognition engine so that in block 375, captioning text of the speech of the speaker is received. Thereafter, in block 380 the captioning text is presented over the primary display (or optionally in a separate window). In decision block 385, it is then determined whether or not the conference has ended. If not, the process returns to block 365 with the receipt of additional audio in an audio stream. But otherwise, the audio stream terminates in block 390 and, to the extent a video stream is open, the video stream also terminates in block 395.

In decision block 315, however, to the extent that it is determined to supplement the conference with an assistive supplement, in block 320, a list of available translators from a pool of known translators is retrieved, for instance by lookup to a table of live translators who, through presence awareness, are determined to be present at a remote computing device and available to participate in the virtual meeting. In block 325, translator criteria preferred by the conference participant who is hard of hearing is retrieved, such as a preferred expertise in specific spoken languages, minimum rating of past performance, geographic location, gender, age, ethnicity and the like. In block 330, the list of available translators is then filtered to only those of the translators known to meet the translator criteria and the list may optionally be sorted to list those of the translators with closest matching criteria first.

In block 335, one of the translators amongst the filtered set is selected by the conference participant who is hard of hearing and in block 340, a network endpoint is determined for the selected translator. The network endpoint can be as simple as an e-mail address or mobile telephone number with which a message can be transmitted including a link to connect to the client computer of the conference participant who is hard of hearing. Or, the network endpoint can be as complex as an Internet protocol address at which a communicative channel can be established directly at the behest of the client computer of the conference participant who is hard of hearing.

In either circumstance in block 345 a communicative channel is established with the selected translator at the network endpoint and in block 350 the audio stream is provided to the computing device at the network endpoint so that the selected translator can hear the speech of the speaker in the conference in real time. To the extent that a video stream also is available as part of the conference, in block 355 a video stream of the conference also is provided to the network endpoint so that the selected translator can observe in real time, the actions of the speaker in the conference. Note, that while the communicative channel is shown to be separate from the conference so as to obscure the presence of the selected translator, in alternative aspects of the embodiment, the selected translator can be invited into the conference as another participant to the conference so that all of the participants to the conference are able to observe the live translation of the speaker in sign language. In any event, in block 360 video of the selected translator performing live sign language translation of the audio stream of the speaker while incorporating the body language of the speaker is received in the computer of the conference participant who is hard of hearing. Thereafter, the process continues with block 365 with the receipt of additional audio in an audio stream.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for the supplementation of an alternative form of audio in a communicative conference for the benefit of the hard of hearing, the method comprising:
capturing audio in a communicative conference between different parties to the conference;
transforming captured audio into an alternative form and displaying the alternative form in connection with the communicative conference;
invoking a companion window to the communicative conference with a view to a live audio interpreter; and,
merging the view to the live audio interpreter with the communicative conference and the alternative form, and transmitting the captured audio to the live audio interpreter while concurrently delivering the captured audio and the alternative form to at least one of the different parties of the conference.

2. The method of claim 1, further comprising selecting the live audio interpreter from a selection of available live audio interpreters known to be available at a time of the invocation of the companion window.

3. The method of claim 2, further comprising filtering the selection according criteria specified by the one of the different parties and pertaining to one or more demographic characteristics of the available live audio interpreters.

4. The method of claim 2, further comprising polling the selection of available live audio interpreters to join the communicative conference and selecting from amongst responding ones of the polled selection a first responding one of the selection of available live audio interpreters.

5. The method of claim 2, further comprising polling the selection of available live audio interpreters to join the communicative conference and selecting from amongst responding ones of the polled selection a responding one of the selection of available live audio interpreters with a highest recorded rating amongst the selection of available live audio interpreters.

6. The method of claim 1, further comprising presenting the view to the live audio interpreter only to the at least one of the different parties of the conference while obscuring the view to the live audio interpreter with respect to remaining ones of the different parties of the conference.

7. A data processing system adapted for supplementing an alternative form of audio in a communicative conference for the benefit of the hard of hearing, the system comprising:
a host computing platform comprising one or more computers, each with memory and one or processing units including one or more processing cores;
a conferencing client executing in the host computing platform and providing access to a communicative conference between different parties to the conference; and,
a supplementation module communicatively coupled to the conferencing client and comprising computer program instructions enabled while executing in the memory of at least one of the processing units of the host computing platform to perform:
capturing audio in the communicative conference;
transforming captured audio into an alternative form and displaying the alternative form in connection with the communicative conference;
invoking a companion window to the communicative conference with a view to a live audio interpreter; and,
merging the view to the live audio interpreter with the communicative conference and the alternative form, and transmitting the captured audio to the live audio interpreter while concurrently delivering the captured audio and the alternative form to at least one of the different parties of the conference.

8. The system of claim 7, wherein the program instructions further perform selecting the live audio interpreter from a selection of available live audio interpreters known to be available at a time of the invocation of the companion window.

9. The system of claim 8, wherein the program instructions further perform filtering the selection according criteria specified by the one of the different parties and pertaining to one or more demographic characteristics of the available live audio interpreters.

10. The system of claim 8, wherein the program instructions further perform polling the selection of available live audio interpreters to join the communicative conference and selecting from amongst responding ones of the polled selection a first responding one of the selection of available live audio interpreters.

11. The system of claim 8, wherein the program instructions further perform polling the selection of available live audio interpreters to join the communicative conference and selecting from amongst responding ones of the polled selection a responding one of the selection of available live audio interpreters with a highest recorded rating amongst the selection of available live audio interpreters.

12. The method of claim 7, wherein the program instructions further perform presenting the view to the live audio interpreter only to the at least one of the different parties of the conference while obscuring the view to the live audio interpreter with respect to remaining ones of the different parties of the conference.

13. A computing device comprising a non-transitory computer readable storage medium having program instructions stored therein, the instructions being executable by at least one processing core of a processing unit to cause the processing unit to perform a supplementation of an alternative form of audio in a communicative conference for the benefit of the hard of hearing, by:
capturing audio in a communicative conference between different parties to the conference;
transforming captured audio into an alternative form and displaying the alternative form in connection with the communicative conference;
invoking a companion window to the communicative conference with a view to a live audio interpreter; and,
merging the view to the live audio interpreter with the communicative conference and the alternative form, and transmitting the captured audio to the live audio interpreter while concurrently delivering the captured audio and the alternative form to at least one of the different parties of the conference.

14. The device of claim 13, wherein the instructions cause the processing unit further to perform selecting the live audio interpreter from a selection of available live audio interpreters known to be available at a time of the invocation of the companion window.

15. The device of claim 14, wherein the instructions cause the processing unit further to perform filtering the selection according criteria specified by the one of the different parties and pertaining to one or more demographic characteristics of the available live audio interpreters.

16. The device of claim 14, wherein the instructions cause the processing unit further to perform polling the selection of available live audio interpreters to join the communicative conference and selecting from amongst responding ones of the polled selection a first responding one of the selection of available live audio interpreters.

17. The device of claim 14, wherein the instructions cause the processing unit further to perform polling the selection of available live audio interpreters to join the communicative conference and selecting from amongst responding ones of the polled selection a responding one of the selection of available live audio interpreters with a highest recorded rating amongst the selection of available live audio interpreters.

18. The device of claim 13, wherein the instructions cause the processing unit further to perform presenting the view to the live audio interpreter only to the at least one of the different parties of the conference while obscuring the view to the live audio interpreter with respect to remaining ones of the different parties of the conference.
